(19) United States
(12) Patent Application Publication
(10) Pub. No.: US 2024/0330515 A1
(43) Pub. Date: Oct. 3, 2024

(54) MANAGING ACCESS TO USER IDENTITIES

(71) Applicant: THE WEATHER COMPANY, LLC, Brookhaven, GA (US)

(72) Inventors: Qaish Shabbir Kanchwala, Atlanta, GA (US); Travis Lee Smith, Roswell, GA (US); Adelbert Noel Madali, Orlando, FL (US)

(21) Appl. No.: 18/128,792

(22) Filed: Mar. 30, 2023

(51) Int. Cl. G06F 21/62

(52) U.S. Cl. CPC G06F 21/6263; G06F 2221/2115

(57) ABSTRACT

A system, method, and computer-implemented method of managing user identities for data control is disclosed. The computer-implemented method is executed in a data processing system comprising a processing device and a memory comprising instructions which are executed by the processing device. The method includes creating a user identity graph, the user identity graph containing entries associated with user identities on a device, with the user identities relating to a user of the device. The method includes detecting an installation of an application on the device. The method includes generating an entry in a user identity graph relating to the application. The method includes receiving a consent instruction from the user relating to the application. The method includes updating the user identity graph based on the consent instruction.

### TECHNICAL FIELD

The present application relates to systems and methods for managing user identities and, more particularly, to systems and methods for managing user identities for data control.

### BACKGROUND

Currently, in the field of computer-executed application, there is no centralized way to manage consent and data control by the user. Each application sets up systems in the backend to manage user consents and the implications that come with it. Connections between systems are managed on the backend on a per-user level in a Customer Data Platform (CDP) that is very expensive. Since the applications control the connections, the user does not have complete transparency as far as which data is being transmitted. The user also has no control over to which third parties their data flows.

Accordingly, systems and methods are needed that will better manage user identities and provide users improved control over their data.

### SUMMARY

Embodiments of the present invention address and overcome one or more of the above shortcomings and drawbacks, by providing systems and methods for managing user identities for data control.

According to an embodiment of the present disclosure, a computer-implemented method of managing user identities for data control in a data processing system including a processing device and a memory comprising instructions which are executed by the processing device is provided. The computer-implemented method includes: creating a user identity graph, wherein the user identity graph contains entries associated with user identities on a device, the user identities relating to a user of the device; detecting an installation of an application on the device; generating an entry in a user identity graph relating to the application; receiving a consent instruction from the user relating to the application; and updating the user identity graph based on the consent instruction.

In some embodiments, the consent instruction can be an acceptance of authorization, and the updating the user identify graph includes: creating a connection between the entry and a first third-party user identity of the user identities.

In some embodiments, the computer-implemented method can further include: detecting an installation of another application on the device; generating another entry in the user identity graph relating to the another application; receiving another acceptance of authorization from the user relating to the another application; and creating a connection between the another entry and the first third-party user identity of the user identities.

In some embodiments, the computer-implemented method can further include: detecting an installation of another application on the device; generating another entry in the user identity graph relating to the another application; receiving another acceptance authorization from the user relating to the another application; and creating a connection between the another entry and a second third-party user identity of the user identities.

In some embodiments, the computer-implemented method can further include: receiving another consent instruction from the user relating to the application, the another consent instruction being a reset of authorization; and severing the connection between the entry and the first third-party user identity.

In some embodiments, the severing the connection between the entry and the first third-party user identity can include deleting the entry.

In some embodiments, the consent instruction can be a denial of authorization, and the updating the user identify graph can include: denying a connection between the entry and a third-party user identity.

According to an embodiment of the present disclosure, a computer program product configured to perform a process to manage user identities for data control is provided. The process includes: creating a user identity graph, the user identity graph containing entries associated with user identities on a device, with the user identities relating to a user of the device; detecting an installation of an application on the device; generating an entry in a user identity graph relating to the application; receiving a consent instruction from the user relating to the application; and updating the user identity graph based on the consent instruction.

In some embodiments, the consent instruction can be an acceptance of authorization, and the updating the user identity graph includes: creating a connection between the entry and a first third-party user identity of the user identities.

In some embodiments, the process can further include: detecting an installation of another application on the device; generating another entry in the user identity graph relating to the another application; receiving another acceptance of authorization from the user relating to the another application; and creating a connection between the another entry and the first third-party user identity of the user identities.

In some embodiments, the process can further include: detecting an installation of another application on the device; generating another entry in the user identity graph relating to the another application; receiving another acceptance authorization from the user relating to the another application; and creating a connection between the another entry and a second third-party user identity of the user identities.

In some embodiments, the process can further include: receiving another consent instruction from the user relating to the application, the another consent instruction being a reset of authorization; and severing the connection between the entry and the first third-party user identity.

In some embodiments, the severing the connection between the entry and the first third-party user identity can include deleting the entry.

In some embodiments, the consent instruction can be a denial of authorization, and the updating the user identity graph can include: denying a connection between the entry and a third-party user identity.

According to an embodiment of the present disclosure, a system of managing user identities for data control is disclosed. The system includes a processing device and a memory comprising instructions that are executed by the processor to perform a method including: creating a user identity graph, the user identity graph containing entries associated with user identities on a device, with the user identities relating to a user of the device; detecting an installation of an application on the device; generating an entry in a user identity graph relating to the application; receiving a consent instruction from the user relating to the application; and updating the user identity graph based on the consent instruction.

In some embodiments, the consent instruction can be an acceptance of authorization, and the updating the user identity graph includes: creating a connection between the entry and a first third-party user identity of the user identities.

In some embodiments, the system can further include: detecting an installation of another application on the device; generating another entry in the user identity graph relating to the another application; receiving another acceptance of authorization from the user relating to the another application; and creating a connection between the another entry and the first third-party user identity of the user identities.

In some embodiments, the system can further include: detecting an installation of another application on the device; generating another entry in the user identity graph relating to the another application; receiving another acceptance authorization from the user relating to the another application; and creating a connection between the another entry and a second third-party user identity of the user identities.

In some embodiments, the system can further include: receiving another consent instruction from the user relating to the application, the another consent instruction being a reset of authorization; and severing the connection between the entry and the first third-party user identity.

In some embodiments, the severing the connection between the entry and the first third-party user identity can include deleting the entry.

In some embodiments, the consent instruction can be a denial of authorization, and the updating the user identity graph can include: denying a connection between the entry and a third-party user identity.

This summary is provided to introduce a selection of concepts in a simplified form that are further described below in the detailed description. This summary is not intended to identify key features or essential features of the claimed subject matter, nor is it intended to be used to limit the scope of the claimed subject matter. Additional features and advantages of the disclosed technology will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1 is a schematic illustration of an exemplary system of managing user identities for data control, depicting communication between a user, a user identity graph, an application, and one or more servers.

FIG. 2 is another schematic illustration of an exemplary system of managing user identities for data control, depicting communication between the user, the user identity graph, the application, and one or more servers.

FIG. 3 is another schematic illustration of an exemplary system of managing user identities for data control, depicting communication between the user, the user identity graph, the application, and one or more servers.

FIG. 4 is another schematic illustration of an exemplary system of managing user identities for data control, depicting communication between the user, the user identity graph, the application, and one or more servers.

FIG. 5 is a flow chart of an exemplary computer-implemented method of managing user identities for data control.

FIG. 6 is a schematic illustration of an exemplary computing system of managing user identities for data control.

### DETAILED DESCRIPTION OF EXEMPLARY EMBODIMENTS

### Overview

The disclosed embodiments provide systems, methods and/or computer program products for managing user identities for data control.

In some embodiments, a user identity graph is created on a computer (which may be embodied in the form of a device for a user). The graph is privacy focused in order to manage user identities directly on the computer/user device (i.e., the front end device/system). A graph of user identities is created, with the user identities being linked based on consents from the user. The links (or lack thereof) between the user identities dictate which systems can connect the users' information and which cannot.

In some embodiments, a central user identity graph is incorporated in a user device that can be accessed and updated by some or all applications installed on the user device. Each application and its third-party code can create identities and access identities from the central user ID graph, if the user accepts the request for access from the application. When the user provides consent to an application to access a third-party data, a link is created in the user device graph between the application user identity and the third-party user identity. By providing access to the third-party identity by the user identity graph, the application can identify the user in the third-party system and share data between the application and the third-party system.

If that request for access is denied, no link is created, and the application cannot identify the user to share data between the application and the third-party system. Similarly, if, after previously granting access to the application to create the link, a user severs that connection between the application and a third-party system by changing their consent to it, the application will not receive the third-party user identity anymore and will sever the connection in the device user identity graph between the application user identity and the third-party identity.

This system and/or method ensures the user has complete control over their data and the ability to decide who can and cannot use it. This also acts as a consent mechanism for each application and process to access user data and store it.

### System and Computer-Implemented Method of Managing User Identities for Data Control

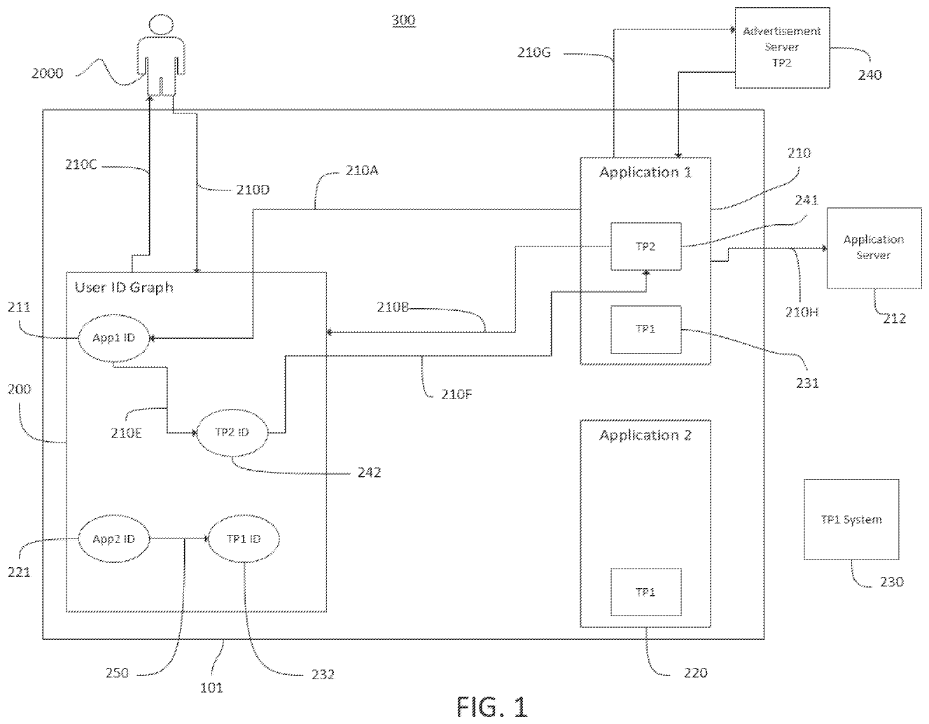

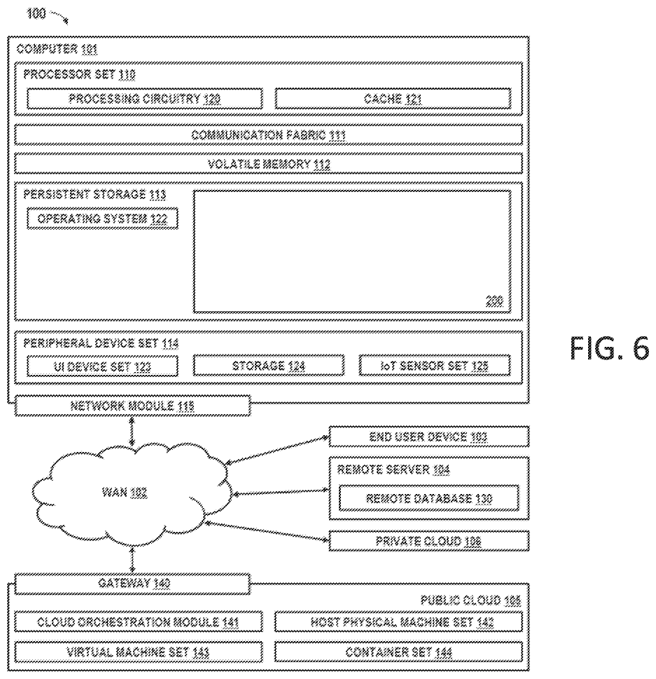

Making reference to FIG. 1, an example of the present disclosure includes a system 300. In this example, a computing device 101 (such as, but not limited to, a smart phone, tablet computer, television or other connected device used by a user 2000) has a centralized user identity graph 200 (note that “identity” and “ID” are used synonymously in the present disclosure), a first application 210, and a second application 220 stored in persistent storage 113 (not shown in FIG. 1 but described in greater detail below with reference to FIG. 6) of the computing device 101. Computing device 101 may be described in greater detail below with reference to FIG. 6. In some examples, the graph 200 and applications 210, 220 can run in a sandbox environment. Taking the first application 210 as a specific example in the present disclosure, the first application 210 can include code 231, 241 integrated therewith from one or more third-party systems, such as a first third-party system 230 (TP1) and a second third party system 240 (TP2). In some examples, TP1 230 can be a Data Management Platform (DMP) for advertisements. In some examples, TP2 240 can be an advertisement server.

In the computing device 101, the central user identity graph 200 is accessible to all applications and processes currently installed on the computing device 101, as well as applications and processes that are installed in the future. In certain examples, each entry in the graph can have the following details:
Entry ID: Unique key of value. This key could be string or integer
Application Namespace ID: To be created by each application or sub process that connects to an external third-party system with respect to the application.
Entry Type: Application/Third-party
User ID: Unique digit string that is randomly generated using a combination of the device state, a random number, adding a salt and hashing it
Access List: List of Entry IDs that are connected to the current Entry

However, those skilled in the pertinent art will appreciate that, in other examples of the present disclosure, this list may include other or exclude certain details, as pertinent, without departing from the spirit and scope of the present disclosure. In the example of FIG. 1, the user 2000 has already consented to a request for access from the second application 220 to TP1 230 (with a sub-process TP1 231 integrated in the second application 220), allowing the second application identity 221 (i.e., the Application Namespace ID described above) and a TP1 identity 232 to establish a link 250 therebetween. When the link 250 is made, the connection details (e.g., TP1 identity 232) are added to the access list.

Continuing reference to FIG. 1, a use case of the user identity graph 200 is as follows. As mentioned above, the graph 200 stores all the identities that application(s) create for a particular user 2000. When a first application 210 is installed, it may include third-party system code 231, 241, such as for advertising. An example of the second third-party code 241 can be, but is not limited to, Google Mobile Ads™ Software Development Kit (SDK) (or another advertisement platform). Advertisement platforms typically create their own ID or use the computer ID that is associated with the computing device 101 in order to identify the user 2000. TP1 231 and TP2 241 are examples of sub-processes, such as third-party SDKs that have been added to an application 210, 220. In order to collect user analytics of activity on the computing device 101, a unique App1 ID 211 (or App2 ID 221) is created by the respective application. These App IDs 211, 221 need to connect with third-party system IDs 231, 241 in order to be able to share data back and forth (e.g., the user analytics).

Accordingly, upon installation of the first application 210 (which can run its own sandbox), it interfaces with the user identity graph 200 to create an entry, referred to herein as App1 ID 211. This is depicted by the arrow corresponding to reference number 210A.

The first application 210 also requests for one or more IDs for sub-process(es) 231, 232 within the first application, which is generally shown by the arrow corresponding to reference number 210B. As those skilled in the pertinent art will appreciate, TP2 ID 242 could be a common ID that exists across applications (i.e., it isn't limited to connection with a single application).

Upon this request, a user 2000 is prompted to accept or deny this request (generally indicated by arrow 210C). The user's response (generally indicated by arrow 210D) is then transmitted back to the user ID graph 200.

If the user 2000 accepts the request, a link/connection 210E is created between the App1 ID 211 and the TP2 ID 241 and the ID values are returned to the TP2 SDK 241 (as shown by arrow 210F). The connection 210E can be made by providing TP2 ID 241 access to the existing entry in the graph 200 for the Application namespace ID of that process (in this example, App1 ID 211) and return the User ID associated with it. This connection 210E allows the first application 210 to connect itself to the advertisement server TP2 240 (as shown by arrow 210G). If the user 2000 denies the request, an anonymous connection with the advertisement server TP2 240 can still be made, but the connection 210G occurs without sending the TP2 ID 241.

If the user 2000 accepts and there is no application namespace ID present for the sub-process 241, the second sub-process 241 from the first application 210 can create a new entry in the graph 200. Further, a new entry is added in the Access List of the entry of the first application 210.

Further, after creating the connection 210E, the first application 210 can also send the App1 ID 211 to its own server 212 (as shown by arrow 210H) to collect any user information/activity that occurs or is generated within the first application 210 during use thereof (e.g., scrolling/clicking activity).

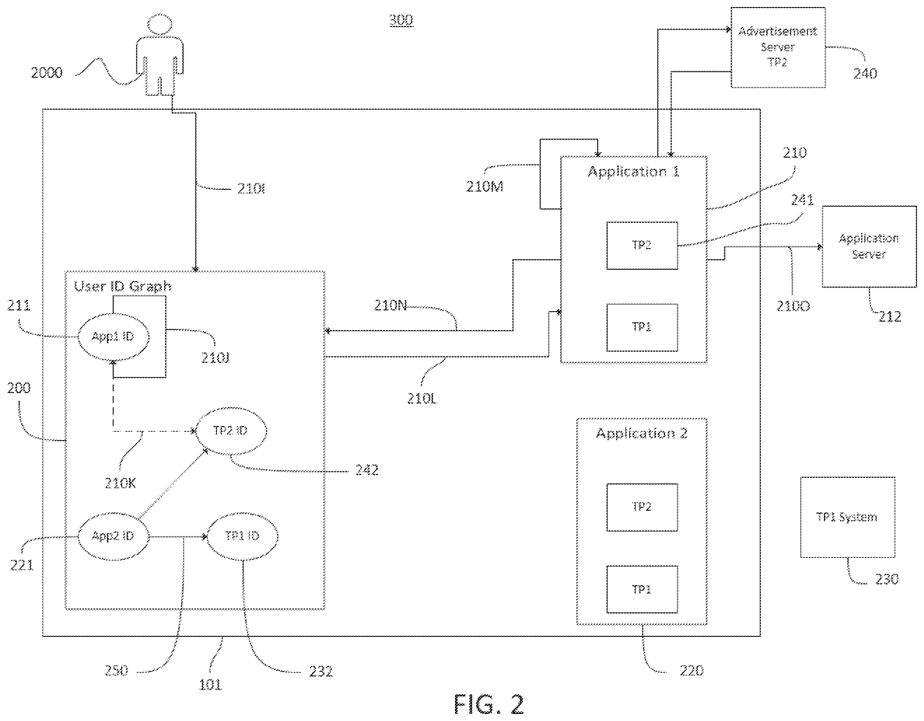

If the request for one or more IDs is denied by the user 2000, the sub-process 241 will only receive a null value and a response of “denied”, which will prevent the sub-process 241 from identifying the user 2000 within its system 240 since there is no user ID available. Other exemplary scenarios are discussed with respect to FIGS. 2-4.

Making reference now to FIG. 2, the user 2000 can choose to reset the User ID, App1 ID 211, of the first application 210 (denoted by arrow 210I). When this happens, the entry of the first application 210 in the User ID graph 200 will be deleted, thus resetting its value (denoted by arrow 210J) and breaking its connection with TP2 ID 242 (denoted by arrow 210K). An ID reset prompt will be transmitted to the first application 210 (denoted by arrow 210L) any local storage provided to the application 210 will be deleted as well (denoted by arrow 210M). This sets up the first application 210 as a fresh install (see arrow 210N) with a new entry created in the User Graph ID 200 with an empty Access List. All consents to share data will have to be provided by the user 2000 again. This reset can also be used by the backend systems (e.g., the application server 212) of applications as a call to delete all data provided by the user (denoted by arrow 210O). All User ID values can be periodically refreshed to ensure that systems with whom connections have been severed are not able to re-identify the users' computing device 101. Effectively, by doing so, the user 2000 will be treated as a completely new user by the first application 210 moving forward. Similar to the process shown and described in FIG. 1, the first application 210 would once again need to request for consent to connect with (or create) the corresponding sub-process ID (e.g., TP2 ID).

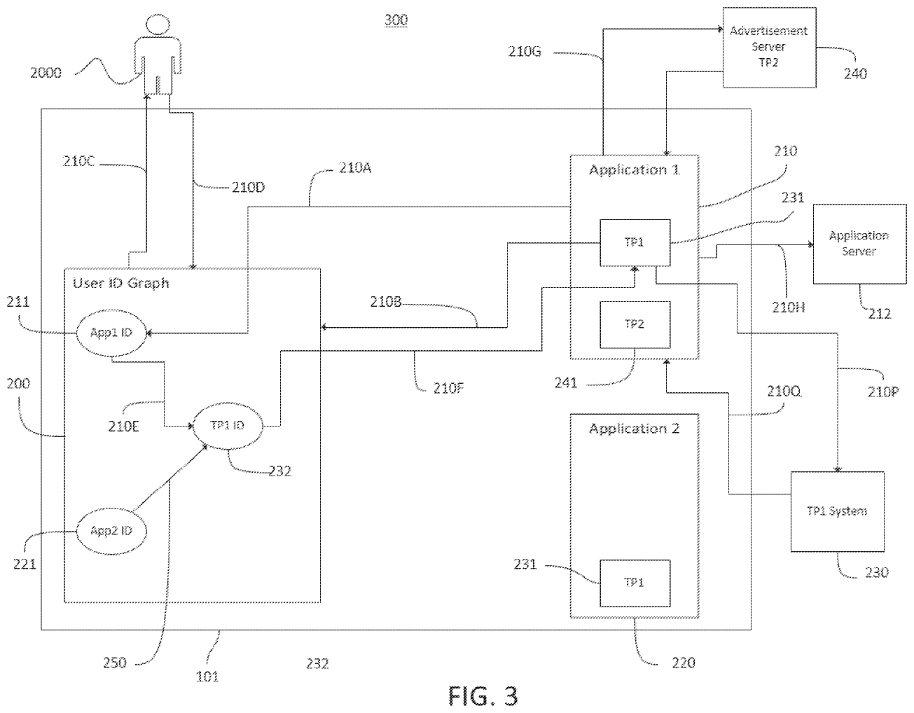

Turning to FIG. 3, a similar scenario to that of FIG. 1 is shown. Accordingly, like reference numbers are not explained in further detail. In this example, the first application 210 and the second application 220 have the same sub-process 231 (associated with DMP 230). Similar to the example in FIG. 1, the second application 221 can already have an existing link 250 with the sub-process ID 232 in the graph 200. In some examples, the second application 221 was the reason for TP1 ID's creation in the first place (i.e., it was the application to first request connection in the user ID graph 200). Rather than the first application 210 requesting creation of a new ID for TP1 231, since it already exists, the first application 210 can request for a connection to be made with the existing TP1 ID 232. Similar to FIG. 1, if access is granted by the user 2000, the connection is made, and the sub-process 231 can communicate with TP1 230 (e.g., a DMP) to request (arrow 210P) and receive (arrow 210Q) user parameters from TP1 230.

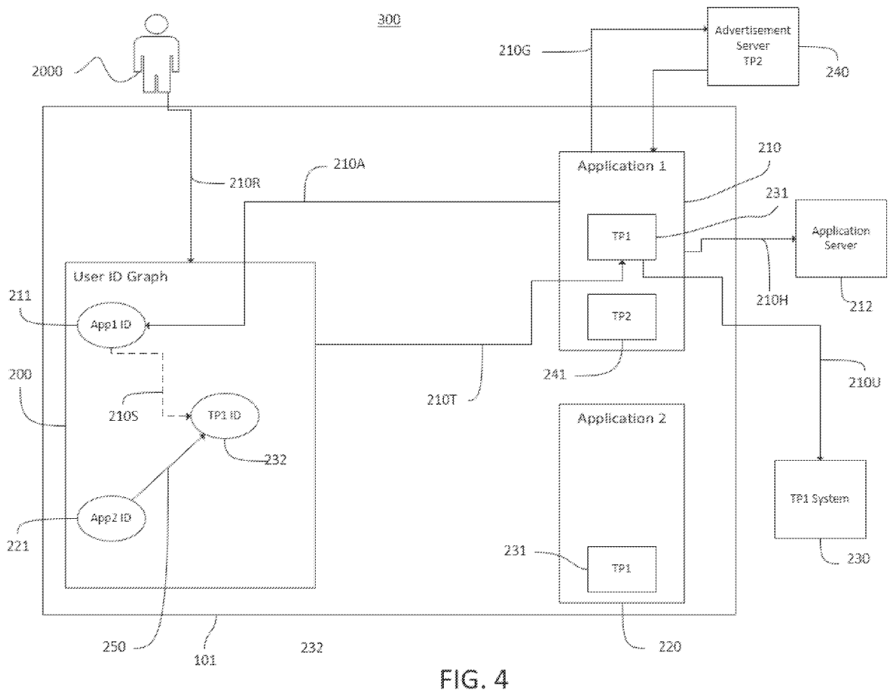

Referring to FIG. 4, an example where a user revokes consent (arrow 210R) for a sub-process 231 in the first application 210 is shown. When consent is revoked, the connection between the sub-process ID 232 and App1 ID 211 is broken (arrow 210S). The value of the sub-process Application namespace ID from the Access list of the Application entry in the graph 200 is deleted, thereby denying access to the application sub-process 231 of the unique ID 232 (arrow 210T). This prevents the first application 210 from connecting to the TP1 system 230. Further, it can also prompt a request to delete data from TP1 230 associated with the user's activity in the first application 210. In this example, the connection (arrow 210U) between TP1 230 and the second application 220 could remain. However, TP1 230 will not be aware that the first application 210 and the second application 220 are actually coming from the same user 2000 because the connection is broken.

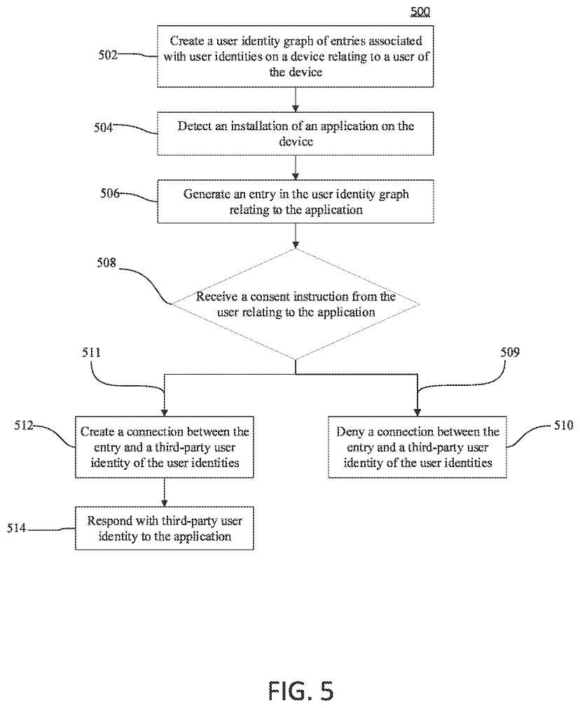

FIG. 5 is a flow chart depicting an exemplary computer-implemented method 500 according to an embodiment of this disclosure. In step 502, a user identity graph of user identities is created on a computer/device. The user identities are associated with a with a user of the device. In step 504, an installation of an application on the device is detected. In step 506, an entry is generated in the user identity graph related to the application. In step 508, a consent authorization is received from a user relating to the application. If the consent instruction is a denial of authorization 509, a subsequent step 510 of denying a connection between the entry and a third-party user identity is taken. If the consent instruction is a consent of authorization 511, a subsequent step 512 of creating a connection between the entry and a third-party user identity is taken. In step 514, a response to the application is sent that includes the third-party user identity.

As those skilled in the pertinent art will appreciate, the present disclosure has many potential uses. For example, it can be used within various operating systems (e.g. IBM z/OS™), security solutions (e.g., IBM Security), and advertising services (e.g., Watson Advertising™). It can be an integral solution for resolving client identity across devices, such as, but not limited to, IoT devices, smart phones, desktop computers, smart TVs, and the like. It can be used within platforms to manage identities for operating systems (OS) on original equipment manufacturer (OEM) devices. It can also be used as a privacy-first component of non-OS software, such as browsers or other applications which operate separately from the OS.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 6 depicting a computing environment system 100, contains an example of an environment, in which system 300 can operate, for the execution of at least some of the computer code involved in performing the inventive methods, such as the user identity graph 200 for managing user identities for improved data control described with respect to FIGS. 1-5. In addition to block 200, computing environment 100 includes, for example, computing device 101, wide area network (WAN) 102, end user device (EUD) 103, remote server 104, public cloud 105, and private cloud 106. In this embodiment, computing device 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computing device 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computing device 101, to keep the presentation as simple as possible. Computing device 101 may be located in a cloud, even though it is not shown in a cloud in FIG. 1. On the other hand, computing device 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computing device 101 to cause a series of operational steps to be performed by processor set 110 of computing device 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computing device 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computing device 101, the volatile memory 112 is located in a single package and is internal to computing device 101, but, alternatively or additionally, the volatile memory may be distributed over multiple packages and/or located externally with respect to computing device 101.

Persistent storage 113 is any form of non-volatile storage for computers that is now known or to be developed in the future. The non-volatility of this storage means that the stored data is maintained regardless of whether power is being supplied to computing device 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computing device 101. Data communication connections between the peripheral devices and the other components of computing device 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computing device 101 is required to have a large amount of storage (for example, where computing device 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computing device 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computing device 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computing device 101), and may take any of the forms discussed above in connection with computing device 101. EUD 103 typically receives helpful and useful data from the operations of computing device 101. For example, in a hypothetical case where computing device 101 is designed to provide a recommendation to an end user, this recommendation would typically be communicated from network module 115 of computing device 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computing device 101. Remote server 104 may be controlled and used by the same entity that operates computing device 101. Remote server 104 represents the machine(s) that collect and store helpful and useful data for use by other computers, such as computing device 101. For example, in a hypothetical case where computing device 101 is designed and programmed to provide a recommendation based on historical data, then this historical data may be provided to computing device 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The present description and claims may make use of the terms “a,” “at least one of,” and “one or more of,” with regard to particular features and elements of the illustrative embodiments. It should be appreciated that these terms and phrases are intended to state that there is at least one of the particular features or elements present in the particular illustrative embodiment, but that more than one can also be present. That is, these terms/phrases are not intended to limit the description or claims to a single feature/element being present or require that a plurality of such features/elements be present. On the contrary, these terms/phrases only require at least a single feature/element with the possibility of a plurality of such features/elements being within the scope of the description and claims.

In addition, it should be appreciated that the description uses a plurality of various examples for various elements of the illustrative embodiments to illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description, that there are many other alternative implementations for these various elements that may be utilized in addition to, or in replacement of, the example provided herein without departing from the spirit and scope of the present invention.

The system and processes of the Figures are not exclusive. Other systems, processes and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112, sixth paragraph, unless the element is expressly recited using the phrase “means for.”

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

We claim:

1. A computer-implemented method of managing user identities for data control in a data processing system comprising a processing device and a memory comprising instructions which are executed by the processing device, the computer-implemented method comprising:
creating a user identity graph, wherein the user identity graph comprises entries associated with user identities on a device, the user identities relating to a user of the device;
detecting an installation of an application on the device;
generating an entry in a user identity graph relating to the application;
receiving a consent instruction from the user relating to the application; and
updating the user identity graph based on the consent instruction.

2. The computer-implemented method of claim 1, wherein the consent instruction is an acceptance of authorization, and wherein the updating the user identity graph further comprises:
creating a connection between the entry and a first third-party user identity of the user identities.

3. The computer-implemented method of claim 2, further comprising:
detecting an installation of another application on the device;
generating another entry in the user identity graph relating to the another application;
receiving another acceptance of authorization from the user relating to the another application; and
creating a connection between the another entry and the first third-party user identity of the user identities.

4. The computer-implemented method of claim 2, further comprising:
detecting an installation of another application on the device;
generating another entry in the user identity graph relating to the another application;
receiving another acceptance authorization from the user relating to the another application; and
creating a connection between the another entry and a second third-party user identity of the user identities.

5. The computer-implemented method of claim 2, further comprising:
receiving another consent instruction from the user relating to the application, the another consent instruction being a reset of authorization; and
severing the connection between the entry and the first third-party user identity.

6. The computer-implemented method of claim 5, wherein the severing the connection between the entry and the first third-party user identity comprises deleting the entry.

7. The computer-implemented method of claim 1, wherein the consent instruction is a denial of authorization, and wherein the updating the user identity graph further comprises:
denying a connection between the entry and a third-party user identity.

8. A computer program product configured to perform a process to manage user identities for data control, the process comprising:
creating a user identity graph, wherein the user identity graph comprises entries associated with user identities on a device, the user identities relating to a user of the device;
detecting an installation of an application on the device;
generating an entry in a user identity graph relating to the application;
receiving a consent instruction from the user relating to the application; and
updating the user identity graph based on the consent instruction.

9. The computer program product of claim 8, wherein the consent instruction is an acceptance of authorization, and wherein the updating the user identity graph further comprises:
creating a connection between the entry and a first third-party user identity of the user identities.

10. The computer program product of claim 9, further comprising:
detecting an installation of another application on the device;
generating another entry in the user identity graph relating to the another application;
receiving another acceptance of authorization from the user relating to the another application; and
creating a connection between the another entry and the first third-party user identity of the user identities.

11. The computer program product of claim 9, further comprising:
detecting an installation of another application on the device;
generating another entry in the user identity graph relating to the another application;
receiving another acceptance authorization from the user relating to the another application; and
creating a connection between the another entry and a second third-party user identity of the user identities.

12. The computer program product of claim 9, further comprising:
receiving another consent instruction from the user relating to the application, the another consent instruction being a reset of authorization; and
severing the connection between the entry and the first third-party user identity.

13. The computer-implemented method of claim 12, wherein the severing the connection between the entry and the first third-party user identity comprises deleting the entry.

14. The computer program product of claim 8, wherein the consent instruction is a denial of authorization, and wherein the updating the user identity graph further comprises:
denying a connection between the entry and a third-party user identity.

15. A system of managing user identities for data control comprising a processing device and a memory comprising instructions that are executed by the processor to perform a method comprising:
creating a user identity graph, wherein the user identity graph comprises entries associated with user identities on a device, the user identities relating to a user of the device;
detecting an installation of an application on the device;
generating an entry in a user identity graph relating to the application;
receiving a consent instruction from the user relating to the application; and
updating the user identity graph based on the consent instruction.

16. The system of claim 15, wherein the consent instruction is an acceptance of authorization, and wherein the updating the user identity graph further comprises:
creating a connection between the entry and a first third-party user identity of the user identities.

17. The system of claim 16, wherein the method further comprises:
detecting an installation of another application on the device;
generating another entry in the user identity graph relating to the another application;
receiving another acceptance of authorization from the user relating to the another application; and
creating a connection between the another entry and the first third-party user identity of the user identities.

18. The system of claim 16, wherein the method further comprises:
detecting an installation of another application on the device;
generating another entry in the user identity graph relating to the another application;
receiving another acceptance authorization from the user relating to the another application; and
creating a connection between the another entry and a second third-party user identity of the user identities.

19. The system of claim 16, wherein the method further comprises:
receiving another consent instruction from the user relating to the application, the another consent instruction being a reset of authorization; and
severing the connection between the entry and the first third-party user identity.

20. The system of claim 15, wherein the consent instruction is a denial of authorization, and wherein the updating the user identify graph further comprises:
denying a connection between the entry and a third-party user identity.
